(19) United States
(12) Patent Application Publication
(10) Pub. No.: US 2005/0194048 A1
(43) Pub. Date: Sep. 8, 2005

(54) Backpressure regulator

(75) Inventors: Timothy P. Duggan, Epsom, NH (US); Kingston Owens, Bedford, NH (US)

Correspondence Address: BROMBERG & SUNSTEIN LLP, 125 SUMMER STREET, BOSTON, MA, 02110-1618, US

(73) Assignee: DEKA Products Limited Partnership, Manchester, NH (US)

(21) Appl. No.: 10/713,644

(22) Filed: Nov. 13, 2003

Related U.S. Application Data
(60) Provisional application No. 60/425,820, filed on Nov. 13, 2002.
(60) Provisional application No. 60/518,782, filed on Nov. 10, 2003.

(51) Int. Cl. F16K 15/03

(52) U.S. Cl. 137/527.8

(57) ABSTRACT

A backpressure regulator, consistent with an embodiment of the invention, includes a hinged arm attached to a movable stop that is positioned to cover a port connected to a pressurized conduit, when the arm of the regulator is in a closed position. When the pressure in the conduit exceeds a set point, the arm moves away from the closed position, allowing fluid to escape the pressurized conduit. When the pressure in the conduit returns to, or below the set point, the arm returns to a closed position. Other backpressure regulators in accord with embodiments of the invention may include an adjustable counter mass for altering the set point of the regulator; a specifically designed leak vent when the arm of the regulator is in a closed position; or a port having an orifice connected to the pressurized conduit. The port may optionally have a drain orifice as well.

### CROSS REFERENCE TO RELATED APPLICATIONS

The present application is a regular application which claims priority from U.S. Provisional Patent Application 60/425,820, filed Nov. 13, 2002, as well as from U.S. Provisional Patent Application, Ser. No. ______, entitled “Locally Powered Water Distillation System,” filed Nov. 10, 2003, all of which applications are incorporated herein by reference.

### TECHNICAL FIELD

The present invention is directed to the field of pressure regulation, and may be especially relevant to fields that utilize a valve for controlling the pressure of gases in pressurized conduits.

### BACKGROUND ART

Backpressure regulators are essential to maintaining the safe and optimal operation of processes conducted under pressure. For example, in a vapor compression distillation system utilized to purify brackish or sea water into drinking water, excess system pressure from start-up volatile components, or created from compressors running off-specification, may constitute a danger to operators if such pressure is not relieved in a safe manner. As well, volatile components present in feed streams at start-up may present contaminants that interfere with proper operation of the system. Backpressure regulators may serve to relieve excess pressure, and to return an operating system to a desired operating pressure.

Some backpressure regulators utilize a spring-biased obstruction blocking a relief port in a pressurized conduit, the obstruction separating from the port when the internal pressure in the conduit exceeds a given set point. Such spring valves are troublesome since they require constant maintenance and recalibration by the valve user due to the changing spring constant value with aging and environmental conditions. The spring valves also require individual, initial calibration due to the variation in spring constant from spring to spring.

The prior art devices may also utilize a weighted ball design that is direct acting, meaning the ball applies a force directly on the port. The downside of direct action is that either the weight required is large or the orifice is too small to enable rapid venting when the valve is open. As well, former weighted ball designs completely seal the port during system start-up, allowing the build up of volatile gasses that act as insulators to heat exchange and suppressors of boiling by inhibiting condensation against the heat exchange surface. Also, adjustment of the set point of the valves depends upon tailoring the weighted ball specifically to a particular application. Finally, many of the prior art devices are directed toward safety relief valves that simply act to relieve a dangerous system pressure condition; such devices do not allow quick restoration of the system to a normal pressure operating condition.

### SUMMARY OF THE INVENTION

One embodiment of the invention is directed to a backpressure regulator. The backpressure regulator includes a hinged arm having a closed position; and a movable stop shaped to cover a port connected to a pressurized conduit, the stop being held by a retainer attached to the arm, and the stop being positioned adjacent to the port when the arm is in the closed position; wherein the arm is away from the closed position when the pressure in the conduit exceeds a set point, and the arm is in the closed position when the pressure in the conduit is less than the set point.

In another embodiment of the invention, the backpressure regulator may include a counter mass adjustably attached to the arm, and the counter mass may be configured so that changing the counter mass position with respect to the arm changes the set point. The counter mass may be adjustably attached such that the lowest set point is substantially less than or equal to 10 psig, or such that the highest set point is substantially greater than or equal to 17 psig.

In a related embodiment of the invention, a backpressure regulator may further include a specifically designed leak vent at least when the arm is in the closed position.

In another related embodiment, the movable stop of a backpressure regulator is substantially ball-shaped.

Other embodiments of the invention utilize the backpressure regulator in a vapor compression distillation system.

In still another embodiment of the invention, a backpressure regulator further includes a vessel having an orifice connected to the pressurized conduit, wherein the port is an opening of the orifice and the arm is hinged to the pressure vessel. The vessel may also include a drain orifice.

### BRIEF DESCRIPTION OF THE DRAWINGS

The foregoing features of the invention will be more readily understood by reference to the following detailed description, taken with reference to the accompanying drawings, in which:

FIG. 1A is side view of a backpressure regulator in accord with an embodiment of the invention;

FIG. 1B is a diagonal view of the backpressure regulator shown in FIG. 1A;

FIG. 2A is a side view of a backpressure regulator with a vertically positioned port in accord with an embodiment of the invention;

FIG. 2B is a diagonal view of the backpressure regulator shown in FIG. 2A;

FIG. 3 is a schematic of a backpressure regulator implemented into a process, consistent with an embodiment of the invention;

FIG. 4A is a diagonal view of a backpressure regulator in accord with an embodiment of the invention;

FIG. 4B shows a close-up view of section C of FIG. 4A, depicting a notch in the port of the backpressure regulator;

FIG. 5A is a cutaway side view of a backpressure regulator consistent with an embodiment of the invention; and

FIG. 5B is a close up view of section E of FIG. 5A, depicting a small opening in an orifice of the backpressure regulator.

### DETAILED DESCRIPTION OF SPECIFIC EMBODIMENTS

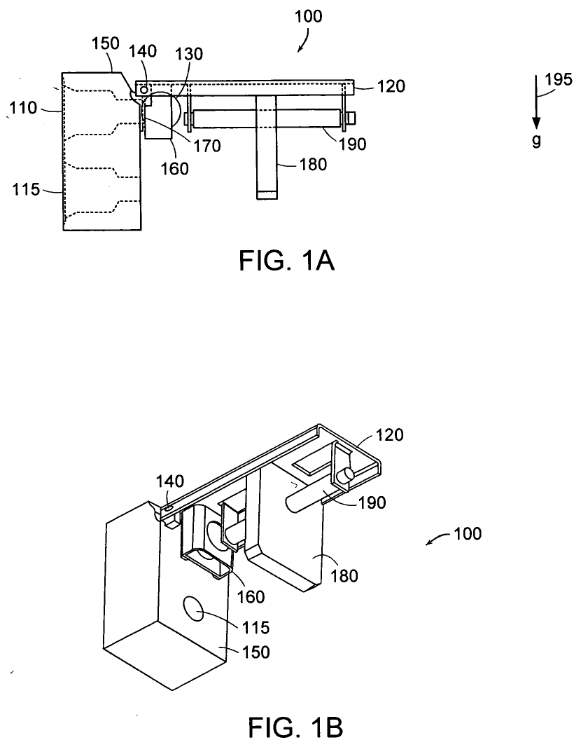

FIGS. 1A and 1B depict views a backpressure regulator consistent with an embodiment of the invention. The backpressure regulator 100 has a vessel 150 containing an orifice 110. One side of the orifice is connected to a pressurized conduit of a system (e.g., the outlet of a compressor in a vapor compression distillation system) which may be exposed to the fluctuating elevated pressure. The other side of the orifice terminates in a port 170. The port 170 is covered by a movable stop 130, in the shape of a ball. The stop 130 is retained to an arm 120 by means of a retainer 160 at a fixed distance from a pivot pin 140. The arm 120 is attached by a hinge via the pivot pin 140 to a point with a fixed relation to the orifice port 170. The arm 120 includes a counter mass 180 suspended from the arm that is movable along an axis 190 such that the distance between the counter mass 180 and the pivot pin 140 may be varied. In the embodiment shown in FIG. 1A, the axial direction of the orifice 110 is perpendicular to the direction of the gravitational vector 195. The backpressure regulator may also include a housing, which prevents foreign matter from entering the regulator and interfering with the function of the internal components.

In operating the embodiment shown in FIGS. 1A and 1B, the arm 120 maintains a horizontal position with respect to the direction of gravity 195 when the pressure in the pressurized conduit is below a given set point; this arm position, in this embodiment, is known as the closed position, and corresponds to the stop 130 covering the port 170. When the pressure in the conduit exceeds the set point, a force acts on the stop 130, which results in a torque acting around the pivot pin 140. The torque acts to rotate the arm 120 around the pivot pin 140 in a counter-clockwise direction, causing the arm to move away from its closed position and exposing the port 170, which allows fluids (e.g.s, gases, liquids, and combinations of both) to escape from the orifice 110. When the pressure in the conduit is relieved below the set point, the force of gas is no longer sufficient to keep the arm 120 away from its closed position; thus, the arm 120 returns to the closed position, and the stop 130 covers the port 170.

In the embodiment of FIGS. 1A and 1B, the arm 120 acts as a lever in creating adjustable moments and serves to multiply the force applied by the counter mass 180 through the stop 130 to the port 170. This force multiplication reduces the weight needed to close the orifice 110 as opposed to a design where the stop 130 alone acts vertically on top of the orifice 110, as in a pressure cooker. Thus a large port size, to promote expedited venting from a pressurized conduit, may be covered by a relatively lightweight, large-sized stop, the counter mass acting to adjust the desired set point; less design effort may be expended in choosing specific port sizes and stop properties. The addition of an axis 190 for adjusting the position of the counter mass 180, in the present embodiment, allows for changes in the multiplier ratio. As the counter mass 180 is moved to a position closer to the pivot pin 140, the multiplier ratio is reduced, creating a lower closing force. If the counter mass 180 is moved farther from the pivot pin 140, the multiplier ratio is increased, hence increasing the closing force. Therefore, the position of the counter mass 180 effectively acts to adjust the set point of the backpressure regulator.

Adjustment of the backpressure regulator set point may be useful, when the backpressure regulator is utilized in systems at higher altitudes. When the atmospheric pressure is lower, the system operating pressure is commensurately lower. As a result, the temperature of the distillation apparatus is lowered, which may adversely affect system performance. As well, such adjustment allows one to identify set points for the backpressure regulator that are desired by the end user. The use of a counter mass to apply the closing force may also lower cost of the backpressure regulator and reduce component fatigue. In a particular embodiment of the invention, the adjustable counter mass is designed to allow a range of set points with a lowest set point substantially less than or equal to 10 psig. and a highest set point substantially greater than or equal to 17 psig. Thus embodiments of the invention allow for precise system pressure regulation, unlike devices which act simply as safety relief valves.

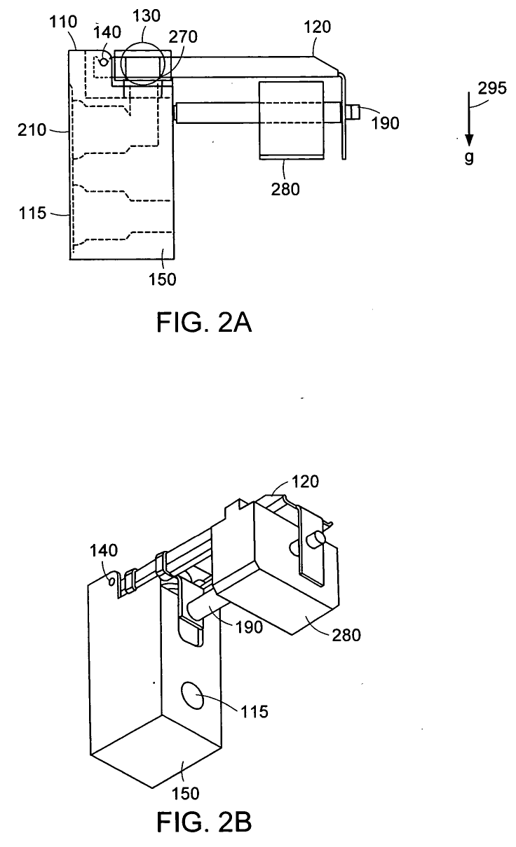

In another embodiment of the invention shown in FIGS. 2A and 2B, the orifice 210 is configured such that the port 270 is oriented vertically with respect to the direction of gravity 295. Thus other embodiments of the invention may accommodate any orifice orientation while maintaining the use of an adjustable counter mass.

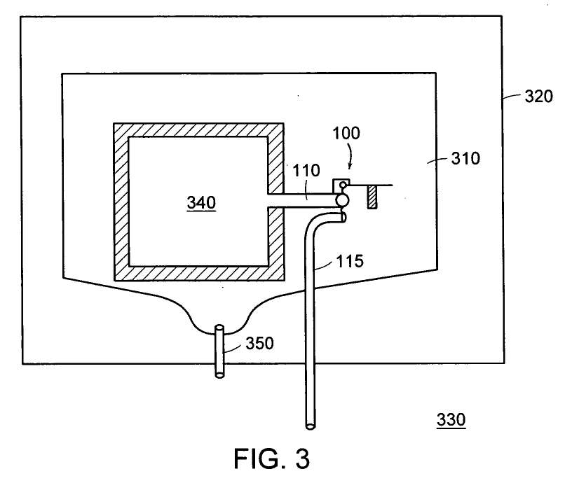

In an embodiment of the invention shown in FIGS. 1A, 1B, and 3, the vessel 150 includes a drain orifice 115. Since the backpressure regulator 100 may operate within a bounded region 310 of a large system 320, the drain orifice 115 acts as a pathway to release fluids that are purged from the pressurized conduit 340 through orifice 110 into the bounded region 310. The drain orifice 115 may connect the bounded region 310 to another area of the larger system, or to the external environment 330. In addition, the build-up of gases in the bounded region 310 may result in condensation of such gases. Also, gases purged through the orifice 110 may be entrained with droplets of liquid that may accumulate in the bounded region 310. Thus the drain orifice 115 may also be used to purge any build up of condensables that accumulate in the bounded region 310; the condensables may also be released from the bounded region using a separate orifice 350.

The backpressure regulator may be configured to allow a small leakage rate below the set point in order to purge the build up of volatile gases that act to insulate heat exchange and suppress boiling in a system; the regulator is designed, however, to allow pressure to build in the pressurized conduit despite this small leakage. In an embodiment of the invention, release of volatile components from a pressurized conduit, below the set point of the backpressure regulator, may also be achieved through a specifically-designed leak vent while the arm of the backpressure regulator is in the closed position. The leak vent is configured to allow a certain leakage rate from the port or the orifice while the pressure in the conduit is below the set point. Such leak vent may be designed by a variety of means known to those skilled in the art. Non-limiting examples include specific positioning of the stop and port to allow a small opening while the arm is in the closed position; designing the port such that a notch in the port results in a small opening when stop covers the port; specifying a particular rigid, non-compliant seal configuration between the stop and port when the arm is in the closed position; and configuring the orifice leading to the port to have a small opening to allow leakage of fluids.

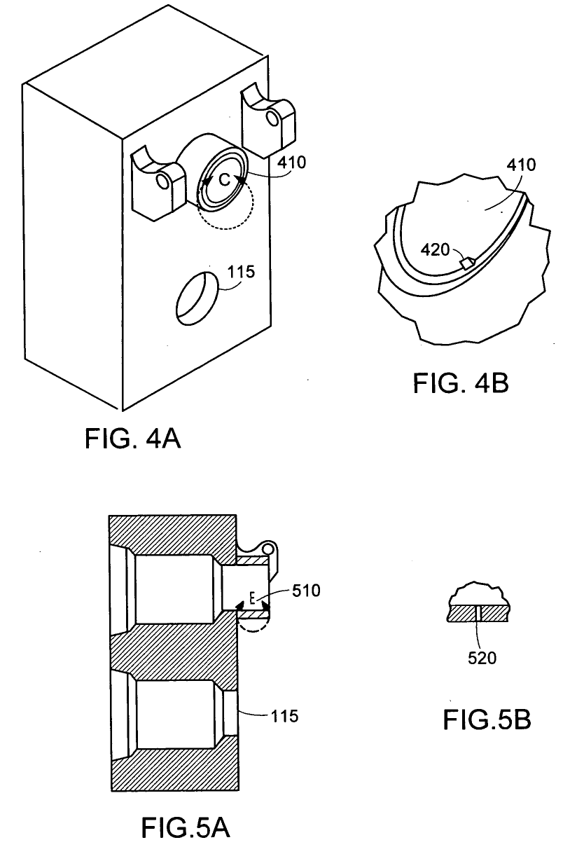

In a particular embodiment of the invention directed toward the leakage of volatiles below the set point of the backpressure regulator, the port 410 has a notch 420 as shown in FIG. 4A and the close-up of region C of FIG. 4A depicted in FIG. 4B. Thus, when a stop is in contact with the port 410, and the arm of the backpressure regulator is in the closed position, a leak vent is present at the position of the notch 420 that allows a leakage of fluid. In another particular embodiment of the invention, orifice 510 has a small opening 520, as depicted in FIG. 5A and blow up of region E of FIG. 5A depicted in FIG. 5B. The opening 520 is configured such that a leak vent is created when the stop covers the port 510 since fluids may leak through the opening 520.

Various features of a backpressure regulator consistent with embodiments of the invention may be altered or modified. For example, stops to be used with backpressure regulators may have any shape, size, or mass consistent with desired operating conditions, such stops need not be ball-shaped as shown in some embodiments of the invention discussed herein. As well, stops of different weight but similar sizes may be utilized with the retainer to alter the set point of the regulator. Similarly, counter masses of different sizes, shapes and masses may be utilized with embodiments of the invention as long as they are accommodated by the axis and arm configurations (compare 180 in FIGS. 1A and 1B with 280 in FIGS. 2A and 2B); such counter masses may be attached and oriented relative to the arm by any of a variety of techniques apparent to those skilled in the art. The pivot pin placement need not be positioned as shown in FIGS. 1 and 2, but may be positioned wherever advantageous to provide the mechanical advantage required to achieve a particular pressure set point.

Embodiments of the invention may optionally utilize the drain orifice feature described earlier. Also, embodiments of the invention may not utilize the counter mass force adjustment feature, relying on the specific properties of a stop to provide the set point for the backpressure regulator.

Other embodiments of the invention may not utilize a vessel, but rely on orifices that are intrinsically part of the system. In such instances, the backpressure regulator arm may be directly attached to a portion of the system such that the arm, stop, and counter mass are appropriately oriented for the operation of the regulator.

It is understood that the present invention is not to be limited by the embodiments of the invention described herein. Indeed, those skilled in the art will readily understand that various modifications and embodiments of the invention may be made and practiced without departing from the scope of the invention.

1. A backpressure regulator comprising:
a hinged arm having a closed position; and
a movable stop shaped to cover a port connected to a pressurized conduit, the stop being held by a retainer attached to the arm, and the stop being positioned adjacent to the port when the arm is in the closed position,
wherein the arm is away from the closed position when the pressure in the conduit exceeds a set point, and the arm is in the closed position when the pressure in the conduit is less than the set point.

2. A backpressure regulator according to claim 1 further comprising a counter mass adjustably attached to the arm.

3. A backpressure regulator according to claim 2, wherein the set point is determined by the position of the counter mass relative to the arm.

4. A backpressure regulator according to claim 2, wherein the counter mass is adjustably attached such that the lowest set point is substantially less than or equal to 10 psig.

5. A backpressure regulator according to claim 2, wherein the counter mass is adjustably attached such that the highest set point is substantially greater than or equal to 17 psig.

6. A backpressure regulator according to claim 1, further comprising a specifically designed leak vent at least when the arm is in the closed position.

7. A backpressure regulator according to claim 1, wherein the movable stop is substantially ball-shaped.

8. A backpressure regulator according to claim 1, wherein the regulator is utilized in a vapor compression distillation system.

9. A backpressure regulator according to claim 1 further comprising a vessel having an orifice connected to the pressurized conduit, wherein the port is an opening of the orifice and the arm is hinged to the pressure vessel.

10. A backpressure regulator according to claim 9, wherein the port includes a notch to release fluids from the pressurized conduit when the arm is in the closed position.

11. A backpressure regulator according to claim 9, wherein the orifice has an opening to release fluids from the pressurized conduit at least when the arm is in the closed position

12. A backpressure regulator according to claim 9, wherein the vessel includes a drain orifice.
